(19) United States
(12) Patent Application Publication
(10) Pub. No.: US 2012/0276925 A1
(43) Pub. Date: Nov. 1, 2012

(54) Location Fidelity Adjustment Based on Mobile Subscriber Privacy Profile

(76) Inventor: Lance Douglas Pitt, Kent, WA (US)

(21) Appl. No.: 13/528,089

(22) Filed: Jun. 20, 2012

Related U.S. Application Data
(63) Continuation-in-part of application No. 13/403,291, filed on Feb. 23, 2012.
Application No. 13/403,291 is a continuation of application No. 10/265,390, filed on Oct. 7, 2002, now Pat. No. 8,126,889.
(60) Provisional application No. 60/367,711, filed on Mar. 28, 2002.
(60) Provisional application No. 60/382,368, filed on May 23, 2002.

(51) Int. Cl. H04W 64/00

(52) U.S. Cl. 455/456.2

(57) ABSTRACT

The present invention utilizes location based wireless technology in a wireless network to dynamically automate the accuracy of location information provided to requesting parties based on external criteria, e.g., the time of day. The location information may be altered by removing particular parts (e.g., by removing street information, or city information), or by mathematically loosening the accuracy of the location of the particular wireless user.

The present application is a continuation-in-part of U.S. application Ser. No. 13/403,291, which is a continuation of U.S. application Ser. No. 10/265,390, now U.S. Pat. No. 8,126,889, which claims priority from U.S. application Ser. No. 60/367,711, filed Mar. 28, 2002, entitled “Mobile Subscriber Privacy Evaluation Using Solicited vs. Unsolicited Differentiation”; and from U.S. application Ser. No. 60/382,368, filed May 23, 2002, entitled “Location Fidelity Adjustment Based on Mobile Subscriber Privacy Profile”, the entirety of all of which are expressly incorporated herein by reference.

### BACKGROUND OF THE INVENTION

1. Field of the Invention

This invention relates generally to wireless and long distance carriers, Internet service providers (ISPs), and information content delivery services/providers and long distance carriers. More particularly, it relates to location services for the wireless industry.

2. Background of Related Art

Location technology in a wireless world essentially is surveillance technology. When location technology is used to provide services other than emergency services it's necessary to allow the mobile subscriber to control to whom their location may be reported.

Currently, privacy solutions in a wireless carrier's network are based on the source of the information. For instance, one conventional solution provides a privacy profile evaluator wherein the wireless user may define the requesting sources to whom location information may be provided.

Other commercial privacy solutions either use a default “opt-out” technique (i.e., the subscriber's privacy info is disseminated unless explicitly denied to all requestors by the subscriber), or a default “opt-in” technique (i.e., the subscriber's privacy info is not disseminated unless explicitly allowed by the subscriber). Either option works well in some scenarios, but may become very cumbersome in other scenarios.

There is a need for a less cumbersome, more efficient and generally better privacy solution, particularly for location based applications.

### SUMMARY OF THE INVENTION

In accordance with the principles of the present invention, a method of adjusting current location information regarding a wireless device comprises receiving a location request for current location information regarding a particular wireless device. A degree of accuracy of the current location information is adjusted corresponding to the particular wireless device from a more accurate version to a less accurate version based on the current location information of the wireless device, the less accurate version being a reduced degree of accuracy of available location information associated with the wireless device. A response to the location request is transmitted as less accurate current location information. In this way the degree of accuracy adjustment is based on a time of day when the location request is received.

In accordance with the principles of another aspect of the present invention, a method of adjusting current location information regarding a wireless device comprises receiving a location request for current location information regarding a particular wireless device. A degree of accuracy of the current location information is adjusted corresponding to the particular wireless device from a more accurate version to a less accurate version based on the current location information of the wireless device, the less accurate version being a reduced degree of accuracy of available location information associated with the wireless device. A response to the location request is transmitted as less accurate current location information. In this way the degree of accuracy adjustment is based on the current location information being within a pre-defined geospatial area, and on a time of day when the location request is received.

### BRIEF DESCRIPTION OF THE DRAWINGS

Features and advantages of the present invention will become apparent to those skilled in the art from the following description with reference to the drawings, in which:

FIG. 1 shows an exemplary location fidelity adjustment system installed in a wireless carrier's network, in accordance with the principles of the present invention.

FIG. 2 depicts various embodiments of a location determiner shown in FIG. 1.

FIG. 3 shows an exemplary subscriber fidelity setting table maintained for each wireless user supported in the fidelity database shown in FIG. 1.

FIG. 4 shows an exemplary process of allowing a subscriber to dynamically adjust their personal location information fidelity, in accordance with the principles of the present invention.

FIG. 5 shows an exemplary process of filtering requested location information in accordance with fidelity settings established for a particular subscriber, in accordance with the principles of the present invention.

### DETAILED DESCRIPTION OF ILLUSTRATIVE EMBODIMENTS

The present invention appreciates that evaluation of a mobile subscriber's privacy should not be just a black or white, yes or no answer based on the source requesting the privacy information, as in conventional systems. Rather, the present invention provides mobile subscribers with the opportunity to mediate the release of all or part of their privacy information (e.g., the accuracy of their location) based, e.g., on the time when the request for their privacy information (e.g., location) is received or based on the subscriber's actual location (e.g. geospatial relationship) or some combination of time and space. In addition, this feature may be augmented with the ability of the subscriber to adjust the amount or accuracy of their privacy information provided, based on the time when the request for their privacy information is received or based on the subscriber's actual location or some combination of time and space.

In accordance with the principles of the present invention, location based wireless services in a service provider's network are commissioned and intertwined with a privacy center to automatically provide a range of location information depending upon the subscriber's particular criteria (e.g., time of day or day of week or geospatial relationship or some combination of a subset of those constraints).

The present invention utilizes location based wireless technology in a wireless network to dynamically automate the accuracy of location information provided to requesting parties based on external criteria, e.g., the time of day or the day of week or geospatial relationship or some combination of a subset of those criteria.

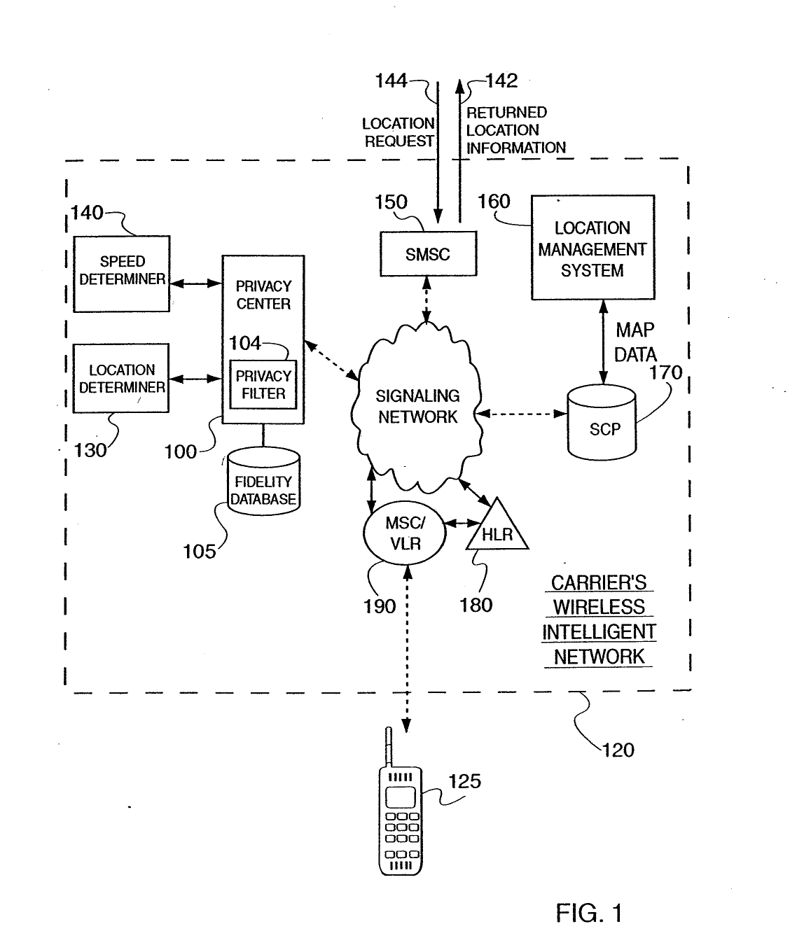

FIG. 1 shows a privacy center application 100 resident in a carrier's wireless intelligent network, in accordance with the principles of the present invention. The privacy center application 100 may be resident in any of many possible elements in the wireless intelligent network, e.g., in the SCP 170, in accordance with the principles of the present invention.

Upon receipt of a location request by a third party, the wireless network 120 communicates with a location management system 160 and a location determiner 130. A speed determiner 140 may optionally be included to provide rate of movement information regarding the subscriber 125.

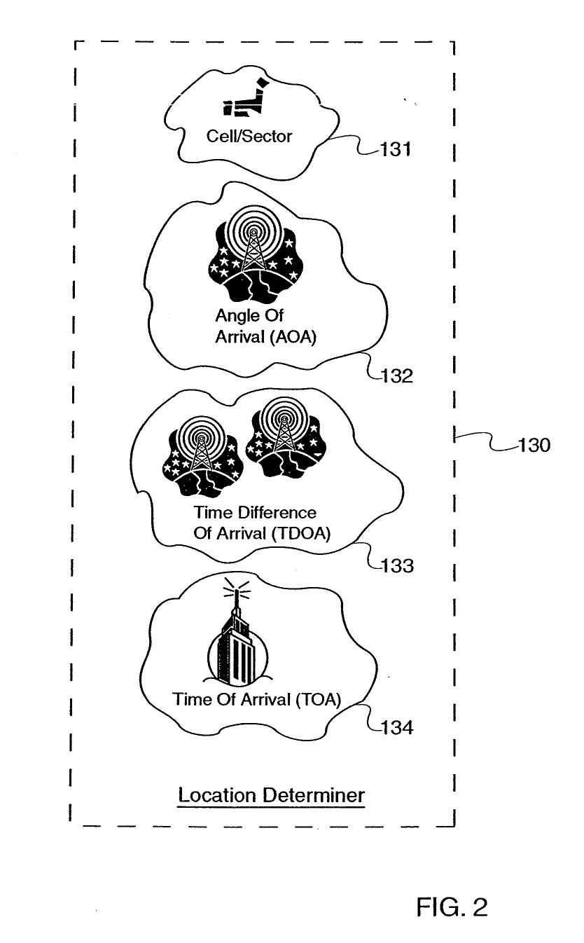

FIG. 2 depicts various embodiments of a location determiner 130 shown in FIG. 1.

In particular, as shown in FIG. 2, the location determiner 130 and location management system 160 perform the location management functions of determining subscriber location. Exemplary techniques implemented in the location determiner 130 may be, e.g., call/sector ID 131, angle of arrival (AOA) 132, time difference of arrival (TDOA) 130, time of arrival (TOA) 134, all of which are otherwise known in the art. The location determiner 130 may include any one or more of the exemplary location modules 131-134 shown in FIG. 2; it need not include all the modules 131-134 shown in FIG. 2. Moreover, these exemplary techniques are exemplary current methods of location determination. The present invention is separate from the particular mechanism used to determine location. Thus, any appropriate location determination mechanism may be used in accordance with the principles of the present invention.

Location information may be determined by a centrally located location determiner 130 (or by an individual wireless user 125 e.g., using a GPS device) and provided to the privacy center 100. Additionally, speed information may optionally be determined by the location management system of the wireless network 120, to augment the location information. For instance, the slower the speed of the subscriber, fewer location updates may be required, lessening the burden on the wireless intelligent network 120.

Returning back to FIG. 1, the wireless network 120 of the disclosed embodiment further includes a Short Message Service Center (SMSC) 150, Message Servicing Center (MSC) with Visitors Location Register (VLR) 190 and Home Location Register (HLR) 180.

The privacy center 100 in accordance with the principles of the present invention utilizes location information determined by a location determiner 130 to provide a proximate location of a wireless user 125, and then importantly adjusts that information based on customized criteria resident in a fidelity database 105 with respect to that particular wireless user 125.

The privacy center 100 may be installed on a dedicated computer system, or may be an application loaded on a computer having other responsibilities and tasks within the wireless network.

The fidelity database 105 contains a plurality of entries, each relating to a particular wireless user 125. For each wireless user, the fidelity of privacy information in general, and location information in particular, may be made less accurate during certain designated times of the day.

In accordance with the principles of the present invention, time and/or location sensitive “fidelity” adjustments to privacy information may be established by the subscriber, on a subscriber-by-subscriber basis. Moreover, the fidelity adjustments may be dynamically changed by the subscriber as their needs change.

“Fidelity” adjustment refers to the ability to filter the amount of private information that is provided to third party requesters, e.g., in a wireless network. In accordance with the principles of the present invention, upon receipt of a request for the location of a particular subscriber, the authorized level of disclosure of privacy information (e.g., location) for that particular wireless user 125 in a fidelity database is checked, and adjusted as necessary, before providing a response to the location request. In response, the location request preferably includes only the authorized portion of the privacy (e.g., location) information (e.g., only a state or a city).

For instance, in the given example of a third party request for the exact location of a particular subscriber, the privacy center 100 receives the request, filters out certain privacy information based on the settings previously established by the subscriber using an appropriate privacy filter 104, and returns the requested location information based on the limitations previously established by the wireless user 125.

For instance, the particular time of receipt of the request for location and/or location of the wireless user 125 may be parameters which alter the amount of private information (e.g., location) that is to be provided to the requesting third party.

As another example, the actual location of a wireless user 125 may, in and of itself, cause an alteration of the amount of private information (e.g., location) to be provided to a requesting third party.

Polygonal boundaries may either be derived from reference information such as zip code or telephone area code or may be specifically designated by the wireless user in advance of queries that cause privacy evaluations. Specific designation of polygonal boundaries are supported in all forms and include, but are not limited to:

1) point and radius for circles
2) center point, major axis, and minor axis for elipses
3) a collection of geographic locations defining a polygon

Geospatial adjustment parameters may overlap or even be contained (i.e. nested) within one another to provide the wireless user 125 advanced ability to create “reporting zones” of high or low fidelity private information.

The present invention is applicable in conjunction with other methods of providing privacy to wireless users. For instance, opt-out or opt-in systems may be in place to exclude (or include) certain third party requesters from receiving any privacy information from a particular wireless user 125.

After determining that a requestor is allowed to get any level of privacy information regarding a particular wireless user 125, the privacy center 100 checks the privacy preferences previously established by the particular wireless user 125 to determine to what degree of accuracy to report the wireless user's location.

For additional information regarding privacy permission techniques and apparatus, please refer to U.S. application Ser. No. 60/367,711, filed Mar. 28, 2002, entitled “Mobile Subscriber Privacy Evaluation Using Solicited vs. Unsolicited Differentiation”, the entirety of which is expressly incorporated herein by reference.

If a preference is applicable, then the privacy center 100 retrieves the required privacy information modifier and passes the same to the application from which the location information will be disseminated (e.g., to the location management system 160). If the wireless user's “found” location is more accurate than allowed by the privacy evaluation determined by the privacy center 100 utilizing the wireless user's criteria stored in the fidelity database 105, then the accuracy of the location information must be reduced to the level previously specified by the wireless user 125. The change in the accuracy of the location information may be performed in the privacy center itself, or within the location management system 160 as instructed by the privacy center 100. Accuracy may be reduced using any otherwise conventional suitable technique, e.g., as is performed by the Global Positioning Satellite (GPS) system in times of war. For instance, instead of providing location information to within a 10 foot accuracy, location information may be provided to within a much larger accuracy, e.g., to within 300 feet by randomly moving the location within the desired window of accuracy.

If, on the other hand, the wireless user's “found” location provided by the location determiner 130 is already less accurate than that allowed by the privacy evaluation of the wireless user's privacy criteria as retrieved from the fidelity database 105, then the relevant application (e.g., the location management system 160 or the privacy center 100 itself) may simply disseminate the “found” location to the requesting party.

In the disclosed embodiment, if no preference is selected by the wireless user 125, then the accuracy of the disclosed privacy information preferably defaults to the most accurate setting (e.g., to the street).

Note that although in the present embodiment location is determined by a centrally located location determiner 130, the principles of the invention relate equally to a GPS or similar device in some or all mobile devices 125.

Voice recognition may be implemented in the carrier's wireless network 120 (e.g., accessible to the SCP 170) to simplify a user's input of relevant information, e.g., in setting privacy criteria in their relevant entry in the fidelity database 105.

The privacy center 100 maintains a list that is checked for the mobile subscriber's information every time information is to be disseminated. While in general the list is checked each time a location request is received, this need not correspond one to one with specific location requests. For instance, one form of location request is a “Periodic Location Request”. This type of request is established once, and then periodically attempts to report a subscriber's location. Thus, the list is checked every time information is to be disseminated.

The privacy center 100 also provides database tables with which customer carriers can initialize some aspects of a new subscriber's privacy profile. This capability is provided to allow customer carriers to configure the system to closely meet the needs of their customer base.

In both cases all the privacy database tables may initially be empty. This allows new wireless users to utilize location enabled services by calling the service (i.e. soliciting the service) without first having to log in to a web site and add the service provider to an “enable” list. This initial state also prevents the wireless user's information from being passed to anyone without their interaction beforehand.

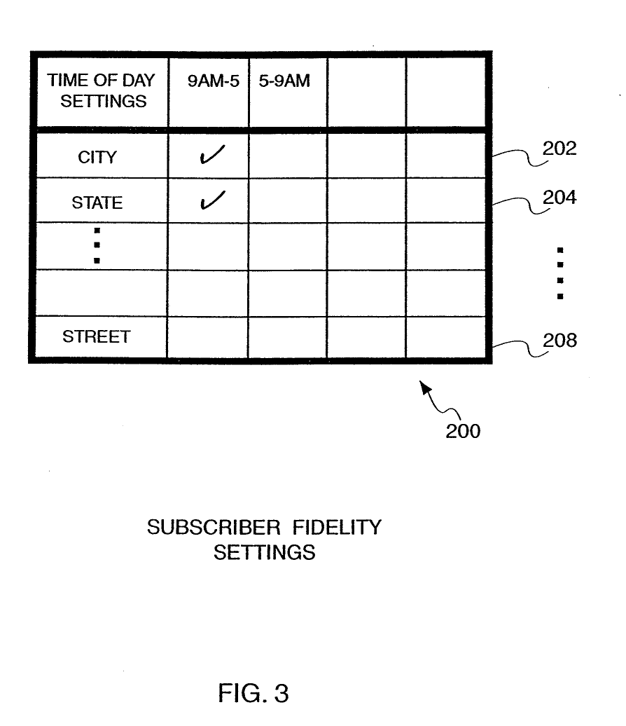

FIG. 3 shows an exemplary subscriber fidelity setting table 200 maintained for each wireless user 125 supported in the fidelity database 105 shown in FIG. 1.

In particular, as shown in FIG. 3, in one disclosed embodiment, a privacy solution in accordance with the principles of the present invention maintains an ordered list of “preferences” for each wireless user (e.g., mobile subscriber) based on given external criteria. For instance, the accuracy of provided location information may be altered based on the particular time-of-day and/or day-of-week and/or geospatial zones in which the wireless user is located when that the location request is received.

In accordance with the principles of the present invention, wireless users may define any of many privacy preferences, e.g., similar in nature to conventional email filters.

Importance may be placed on the ordering of preferences listed for any particular wireless user 125. For instance, the individual entries 202-208 for a particular wireless user 125 may be specifically ordered by the wireless user such that the preferences may be analyzed by the privacy center 100 in the same order. In the given embodiment, preference analysis stops once the first applicable preference is found, making the ordering of individual entries or preferences 202-208 important in such an embodiment.

In the given embodiment, every preference 202-208 in the fidelity settings table 200 can be made up of zero (0) to many constraints and one and only one modifier. Time-of-day and day-of-week are examples of preference constraints. Allowed Accuracy (i.e. street, city, zip code, state, country, or NONE) is an example of a preference modifier.

Any preference with no constraints may be considered “unconstrained” and thus will always be applicable.

Time-of-day and day-of-week constraints are preferably each entered as pairs of values with which ranges may be defined. Preferences with only time-of-day constraints will be applicable in that range of hours every day. Preferences with only day-of-week constraints will be applicable in that range of days every week. Preferences with both time-of-day and day-of-week constraints will be applicable in that range of hours during that range of days every week. Preferences with only geospatial definitions will be applicable only when the wireless user is within the defined area. Preferences with both time-based and geospatial constraints will be applicable only during that range of hours and/or days and only if the wireless user is within the defined area.

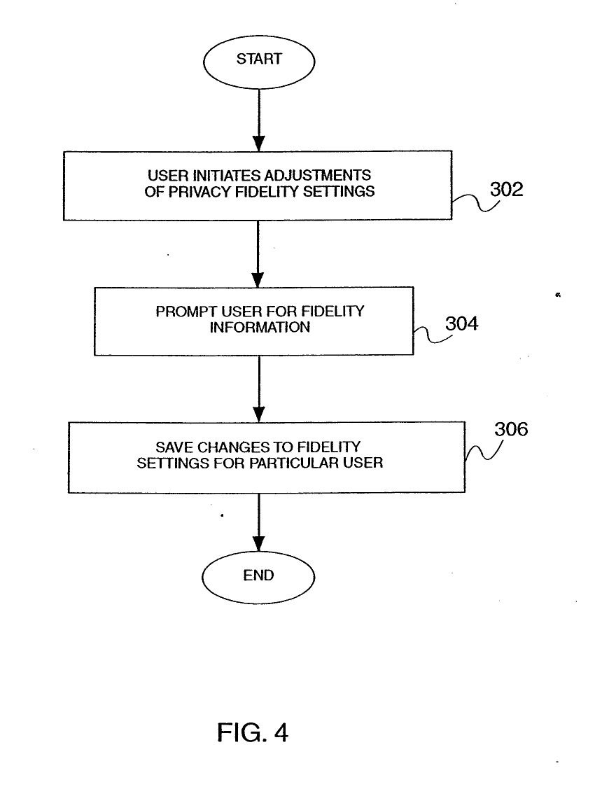

FIG. 4 shows an exemplary process of allowing a subscriber to dynamically adjust their personal location information fidelity, in accordance with the principles of the present invention.

In particular, as shown in step 302 of FIG. 4, a wireless user 125 initiates adjustment of their customizable privacy fidelity preferences 202-208 in the fidelity table 200 stored in the fidelity database 105 relating to them.

In step 304, the wireless user 125 may be prompted (e.g., audibly) for parameters and modifiers from a given menu of options.

In step 306, the selected parameters and modifiers are saved to the fidelity database 105 for use by the privacy center 100.

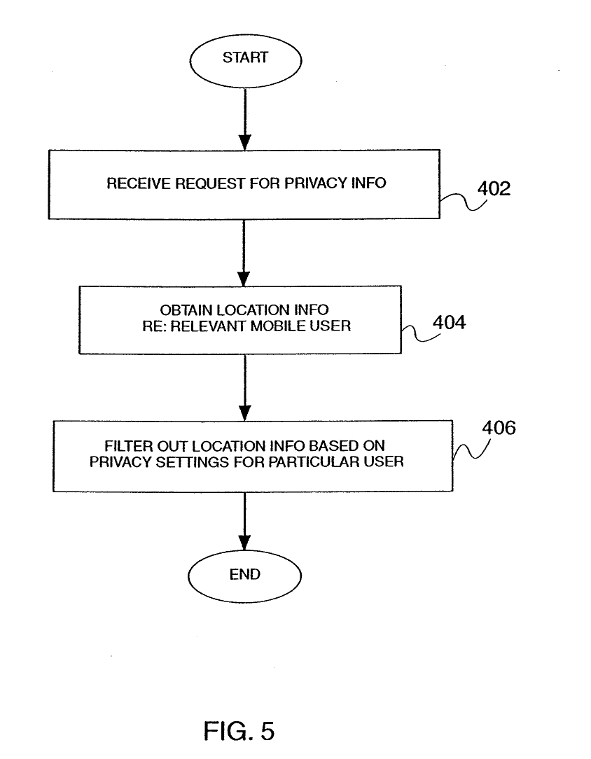

FIG. 5 shows an exemplary process of filtering requested location information in accordance with fidelity settings established for a particular subscriber, in accordance with the principles of the present invention.

In particular, as shown in step 402 of FIG. 5, the privacy center 100 receives word of a request for privacy information (e.g., location) of a wireless subscriber 125 within the wireless intelligent network 120.

In step 404, location information is obtained regarding a relevant wireless user 125 from the location determiner 130.

In step 406, a privacy filter function 104 in the privacy center 100 (or other system such as the location management system 160) filters out unauthorized location information based on privacy settings for the requested wireless user 125.

In the disclosed embodiments, location information is made less accurate by removing particular information such as the state, the city, the street, etc. at which the wireless user 125 currently exists. However, the present invention relates equally to a mathematical alteration of the accuracy of location information. For instance, if location information is available to within 10 meters, but less accurate location information is to be provided to a particular requester, the location information may be randomly altered by a given amount (e.g., adding 100 to 1000 meters to the determined location), or may be provided only to within a given region.

While the invention has been described with reference to the exemplary embodiments thereof, those skilled in the art will be able to make various modifications to the described embodiments of the invention without departing from the true spirit and scope of the invention.

What is claimed is:

1. A method of adjusting current location information regarding a wireless device, comprising:
receiving a location request for current location information regarding a particular wireless device;
adjusting a degree of accuracy of said current location information corresponding to said particular wireless device from a more accurate version to a less accurate version based on said current location information of said wireless device, said less accurate version being a reduced degree of accuracy of available location information associated with said wireless device; and
transmitting, as a response to said location request, said less accurate current location information;
wherein said degree of accuracy adjustment is based on a time of day when said location request is received.

2. The method of adjusting current location information regarding a wireless device according to claim 1, wherein:
said degree of accuracy adjusted is based both on a time of day when said location request is received, and on an actual location of said particular wireless device.

3. A method of adjusting current location information regarding a wireless device, comprising:
receiving a location request for current location information regarding a particular wireless device;
adjusting a degree of accuracy of said current location information corresponding to said particular wireless device from a more accurate version to a less accurate version based on said current location information of said wireless device, said less accurate version being a reduced degree of accuracy of available location information associated with said wireless device; and
transmitting, as a response to said location request, said less accurate current location information;
wherein said degree of accuracy adjustment is based on said current location information being within a pre-defined geospatial area, and on a time of day when said location request is received.

4. The method of adjusting current location information regarding a wireless device according to claim 3, wherein:
said pre-defined geospatial area is defined by a polygonal boundary.

5. The method of adjusting current location information regarding a wireless device according to claim 3, wherein:
said polygonal boundary is defined by point and radius for circles.

6. The method of adjusting current location information regarding a wireless device according to claim 3, wherein:
said polygonal boundary is defined by a center point, major axis, and minor axis for an ellipse.

7. The method of adjusting current location information regarding a wireless device according to claim 3, wherein:
said polygonal boundary may overlap another polygonal boundary.

8. The method of adjusting current location information regarding a wireless device according to claim 3, wherein:
said pre-defined geospatial area is derived from a ZIP code.

9. The method of adjusting current location information regarding a wireless device according to claim 3, wherein:
said pre-defined geospatial area is derived from a phone area code.

10. The method of adjusting current location information regarding a wireless device according to claim 3, wherein:
said polygonal geospatial area is pre-designated in advance of said location request.

11. The method of adjusting current location information regarding a wireless device according to claim 10, wherein:
said polygonal geospatial area is pre-designated by said wireless device.
